(19) United States
(12) Patent Application Publication
(10) Pub. No.: US 2014/0055229 A1
(43) Pub. Date: Feb. 27, 2014

(54) INFRA RED BASED DEVICES FOR GUIDING BLIND AND VISUALLY IMPAIRED PERSONS

(71) Applicants: Amir Amedi, Jerusalem (IL); Shlomo Hanassy, Ashdod (IL)

(72) Inventors: Amir Amedi, Jerusalem (IL); Shlomo Hanassy, Ashdod (IL)

(21) Appl. No.: 13/976,032

(22) PCT Filed: Dec. 19, 2011
(86) PCT No.: PCT/IB11/55774

§ 371 Date: Nov. 12, 2013

Related U.S. Application Data
(60) Provisional application No. 61/427,185, filed on Dec. 26, 2010.

(51) Int. Cl. G09B 21/00

(52) U.S. Cl. CPC G09B 21/001
USPC 340/4.1

(57) ABSTRACT

A method and device for guiding a blind or visually impaired person are provided herein. The method includes the following stages: emitting one or more Infra Red (IR) light beams (110, 340) into a scene that contains objects (20, 50), each beam (110, 340) is associated with a unique direction and further creates an IR light spot (120) on an object (20, 50) facing the light beam (110, 340); converting one or more direct IR reflections from the one or more spots (120), each associated with a unique direction, into respective electrical signals representative of a distance from the one or more spots respectively; producing, for each IR reflection and based on the respective electrical signals and a respective conversion key, a sensual signal comprising an auditory and/or vibratory signal, representative of the distance from the one or more spots respectively; and presenting a combination of the sensual signals, such that each sensual signal associated with a unique direction is auditorily or tactilely distinguishable.

### BACKGROUND

1. Technical Field

The present invention relates to a guiding tool for blind and visually impaired persons, and more particularly to such devices based on infra red directional light beams.

2. Discussion of the Related Art

Walking canes (also known as white canes or walking sticks) have been for many years the standard guiding tool for blind and visually impaired persons. Canes provide direct tactile information regarding obstacles in the blind's peri-personal space only, at a specified distance (of approximately 1.2 m), usually in a predetermined scan maneuver carried out by the person holding the cane.

Several attempts have been made throughout the years to replace the standard walking canes with electronic devices that provide similar or better indication regarding distances and the immediate environment. Known technologies used for distance sensing as a guiding tool for blind and visually impaired persons include: ultra sound, coherent light (laser), image processing, and parallax analysis.

### BRIEF SUMMARY

One aspect of the invention provides a device for guiding a blind or visually impaired person by augmenting his or her ability to estimate the distance and shape of the objects within and outside the his or her peripersonal space. The device includes: one or more Infra Red (IR) emitter-sensor pairs, each pair having an emitter and a sensor pointing at a same spatial angle; a sensual signal generator; and an output unit. In operation, the emitter in each one of the pairs is configured to emit an IR light beam into a scene that contains objects, wherein each beam is associated with a unique direction and further creates an IR light spot on an object facing the emitter. Additionally, the sensor in each one of the pairs is configured to convert a direct IR reflections arriving from the spot associated with a respective emitter, into a respective electrical signal representative of a distance from the spot to the respective emitter. The sensual signal generator is configured to produce, for each IR reflection and based on the respective electrical signals and a respective conversion key, a sensual signal comprising an auditory signal and/or a vibratory signal, representative of the distance from the device to the one or more spots respectively. Additionally, the output unit is further configured to present a combination of the sensual signals to the blind or visually impaired person, such that each sensual signal associated with a unique direction is auditorily or vibratorily distinguishable from sensual signals associated with other directions.

Another aspect of the invention provides a method for guiding a blind or visually impaired person. The method may include the following stages: emitting one or more Infra Red (IR) light focused beams into a scene that contains objects, each beam is associated with a unique direction and further creates an IR light spot on an object facing the light beam; converting one or more direct IR reflections from the one or more spots, each associated with a unique direction, into respective electrical signals representative of a distance from the one or more spots respectively; producing, for each IR reflection and based on the respective electrical signals and a respective conversion key, a sensual signal comprising an auditory or vibratory signal, representative of the distance from the one or more spots respectively; and presenting a combination of the sensual signals, such that each sensual signal associated with a unique direction is auditorily or tactilely distinguishable.

These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a perspective view illustrating an environment of a system according to some embodiments of the invention;

FIGS. 2A and 2B are high level schematic block diagrams, each illustrating the system according to some embodiments of the invention;

FIGS. 3A-3D are perspective views illustrating aspects according to some embodiments of the invention;

FIGS. 4A-4D are perspective views illustrating aspects according to some embodiments of the invention; and

FIG. 5 is a high level flowchart illustrating a method according to some embodiments of the invention.

The drawings together with the following detailed description make apparent to those skilled in the art how the invention may be embodied in practice.

### DETAILED DESCRIPTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments and may be practiced or carried out in various ways. Also, it is to be understood that the phraseology and terminology employed herein is for the purpose of description and should not be regarded as limiting.

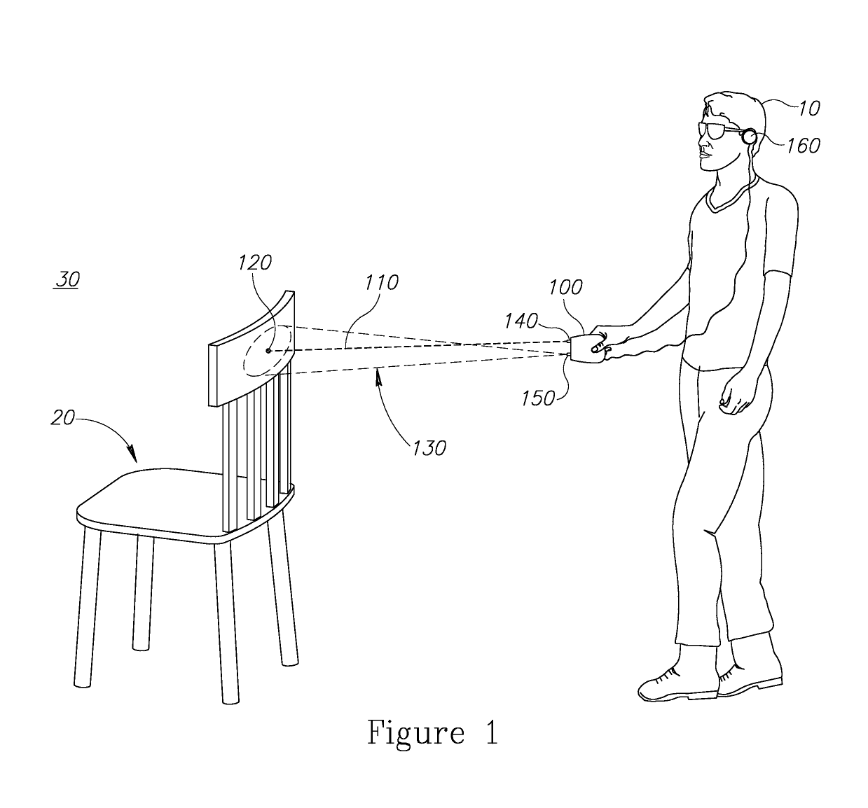

FIG. 1 is a high level schematic block diagram illustrating an environment of a system according to some embodiments of the invention. A blind or visually impaired person 10 is standing facing a specific scene 30 that includes a chair 20. A device 100 in accordance with embodiment of the present invention is held in his hand and directed forward towards chair 20. Device 100 includes a pair of Infra Red (IR) emitter-sensor that includes an IR emitter 140 and an IR sensor 150. In operation, IR emitter 140 emits a highly directional IR light beam 110 that hits chair 20 and creates an IR light spot 120. Reflections from spot 120 hit IR sensor 150 that has an opening angle that creates a specified detection cone 130 that is sufficient to accommodate the reflection from a spot created by IR emitter 140 that is paired with IR sensor 150. Within device 100, a conversion mechanism converts, based on a specified conversion key, characteristics of the reflections into a sensual signal indicative of the distance between device 100 and spot 120 (which represents chair 20). Sensual signal may be embodied as a tactile signal, for example as a vibratory actuation of the housing of device 100 or alternatively as an auditory signal outputted to person 10 via earphones 160. Additionally, both tactile and auditory signals may be combined. Device 100 is designed, as shown in detail below, to enable person 10 to scan scene 30 continuously and receive in response a continuous, tempo-spatial signal of distance changes throughout the scene. This end is achieved, inter alia, by using a highly directional IR light beam (e.g., a beam angle smaller than 5°) and a high refresh rate of the IR light beam (e.g., higher than 50 Hz). In other words, a small movement of device 100 reflects, via the sensual signal, the changes in the distance from objects in the scene such as chair 20. Advantageously, a blind or visually impaired person 10 may, by carrying out a specified scan pattern learn the spatial environment of scene 30 including the shapes, orientation and layout of the objects in the scene.

When using two or more emitter-sensor pairs, as illustrated in further detail below, such that each pair is directed to a different predefined direction, person 100 may receive simultaneously the aforementioned spatial data associated with different directions that are distinguishable. Thus, in a top-middle-bottom partitioning of the space or center-left-right partitioning of directions that are distinguishable, person 10 may know which obstacles are associated with which height, a property currently lacking in standard walking canes.

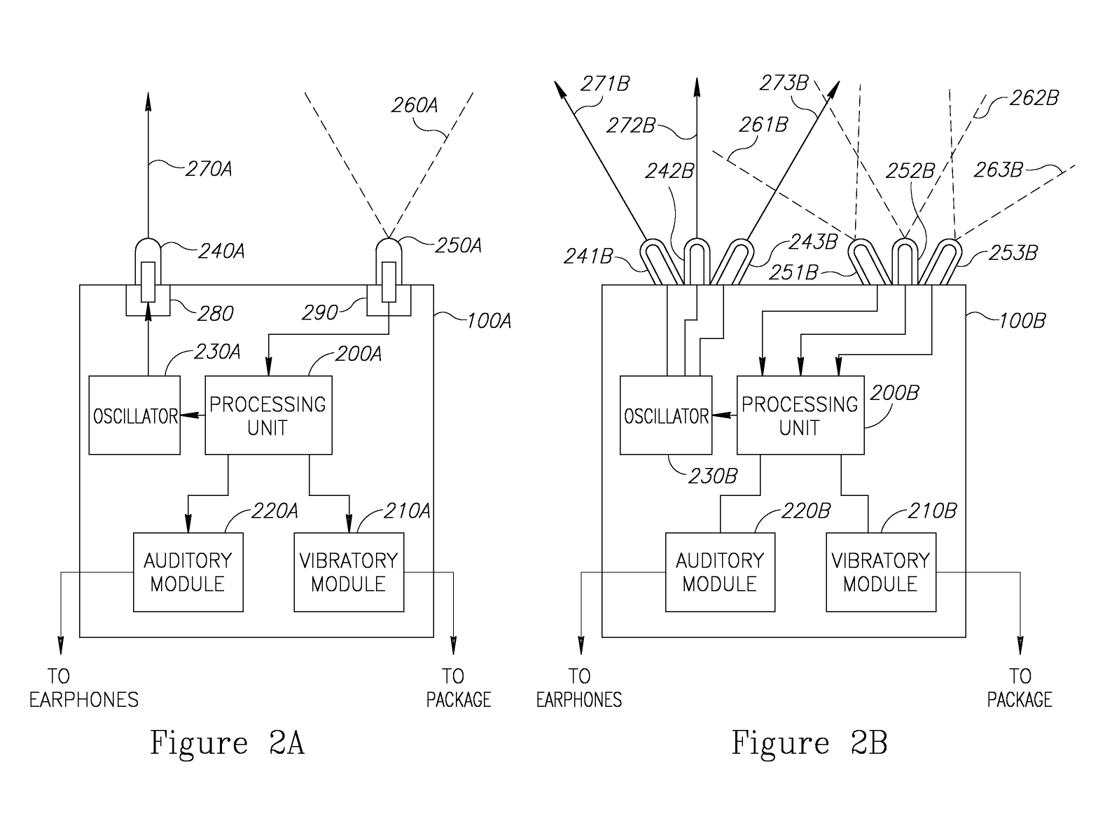

FIGS. 2A and 2B are high level schematic block diagrams, each illustrating the system according to some embodiments of the invention. FIG. 2A shows device 100A for guiding a blind or visually impaired person. The device includes: a single Infra Red (IR) emitter-sensor pair, having an emitter 240A and a sensor 250A pointing at a same spatial angle; a sensual signal generator 200A; and an output unit (being auditory module 220A and vibratory module 210A). In operation, the emitter 240A in the pair is configured to emit an IR light beam 270A in cooperation with oscillator 230A into a scene that contains objects, wherein each beam is associated with a unique direction and further creates an IR light spot on an object facing the emitter 240A. Additionally, the sensor 250A in the pair is configured, possibly in cooperation with processing unit 200B, to convert the direct IR reflections arriving from the spot associated with emitter 240A, and detected within its corresponding detection cone 260A, into a respective electrical signal representative of a distance from the spot to sensor 250A. The sensual signal generator 200A is configured to produce, for each IR reflection and based on the respective electrical signals and a respective conversion key, a sensual signal comprising at least an auditory signal and/or a vibratory signal, representative of the distance from the device to the one or more spots respectively. Additionally, the output units 220A and 210A are further configured to present a combination of the sensual signals to the blind or visually impaired person, such that each sensual signal associated with a unique direction is auditorily or vibratorily distinguishable from sensual signals associated with other directions.

Consistent with one embodiment of the invention, both emitter 240A and sensor 250A are coupled each with a scanning unit 280 and 290 respectively. scanning units 280 and 290 are configured to co-ordinately move the IR light beam 270A and respective detection cone 260A so that the scene is being scanned in a predefined pattern known or determined by the user so that device 100A may remain stationary.

According to another embodiment of the present invention, several pairs of IR emitter-sensors are provided as shown in FIG. 2B. Device 100B includes three pairs of IR emitter-sensor, emitters being 241B-243B (and respective oscillator(s) 230B) emitting IR light beams 271B-273B respectively and IR sensors 251B-253B associated each with detection cones 261B-263B respectively. By a similar operation described above in regards with device 100A, device 100B also converts the reflection into a sensual signal representative of the distance between each one of the sensors 251B-253B and spots upon objects in the scene. However, the use of several pairs, each directed at a different direction provides information from several angles so that the spatial perception is more comprehensive. In order to achieve this end, each sensual signal associated with each one of the different direction has to be either auditorily or tactilely distinguishable from the rest of the sensual signals (associated with other directions).

Consistent with one embodiment of the invention, the conversion key used for converting IR reflections into sensual signals indicative of distance may be unique for each pair and selected such that the vibratory signal exhibits, for example, higher values of at least one of: frequency and amplitude, for shorter distances, or activates actuators on different locations on the person's body. Similarly, the conversion key may be unique for each pair and selected such that the auditory signal exhibits higher values of at least one of: pitch and amplitude, for shorter distances.

Consistent with one embodiment of the invention, the conversion key is unique for each pair and selected such that it assigns a specified modulation for the auditory and vibratory signals respectively. These modulations may be, in the case of vibratory signal—different types of vibration waveforms. In the case of auditory signals—different types of audio waveforms that may be distinguishable, for example by representing different types of musical instruments.

Consistent with one embodiment of the invention, the one or more emitters are selected such that the respective IR light beams exhibit a beam angle equal to or smaller than 5° while aiming at a distance associated with a standard walking cane being 1.2 m, and in some applications, for distances above 4 m, a beam angle smaller than 1° would be preferred.

Consistent with one embodiment of the invention, the one or more emitters are selected such that the respective IR light beams exhibit a refresh rate equal to or greater than 50 Hz. The applicants have discovered that such a refresh rate is sufficient to maintain continuous indication of the distance over time, while scanning the scene using the device according to embodiments of the present invention. The continuous indication of distance is advantageous in providing an enhanced spatial perception of the scene as it enables a realistic study of the shapes, the orientation and relative location of the objects within the studied scene.

Consistent with one embodiment of the invention, the one or more sensors further comprise a colour detector configured to generate colour indicator signals based on specified wavelengths of colour light received by the colour detector, and wherein the sensual signal generator is further configured to generate at least one of: an auditory signal or a vibratory signal also based on the wavelength of the received colour light from each one of the one or more sensors. Additionally and alternatively, a specified modulation may also be applied to the signals thus conveying the information via the modulation parameters.

Consistent with one embodiment of the invention, wherein the sensual signal generator is further configured to assign a unique musical instrument for each auditory signal associated with an IR reflection arriving from a different direction.

Consistent with one embodiment of the invention, the light beams exhibit a refresh rate sufficiently high and wherein the conversion keys are calibrated such that pointing the one or more emitters continuously yields a distinguishable change in the auditory or vibratory signals. Alternatively, the light beams exhibit a refresh rate sufficiently high and wherein the conversion keys are calibrated such that a continuous change in the distance from the device to the one or more spots results in a continuous change in the respective auditory or vibratory signals.

Consistent with one embodiment of the invention, the device may be designed to weigh below 200 grams. Similarly and alternatively, the sensor and the emitter may be located within a compact housing so that the emitter-sensor pair is located within 7 cm from each other. Advantageously, these dimensions enable the use of the device according to embodiments of the present invention as a scanning tool usable for studying the spatial characteristics of the scene.

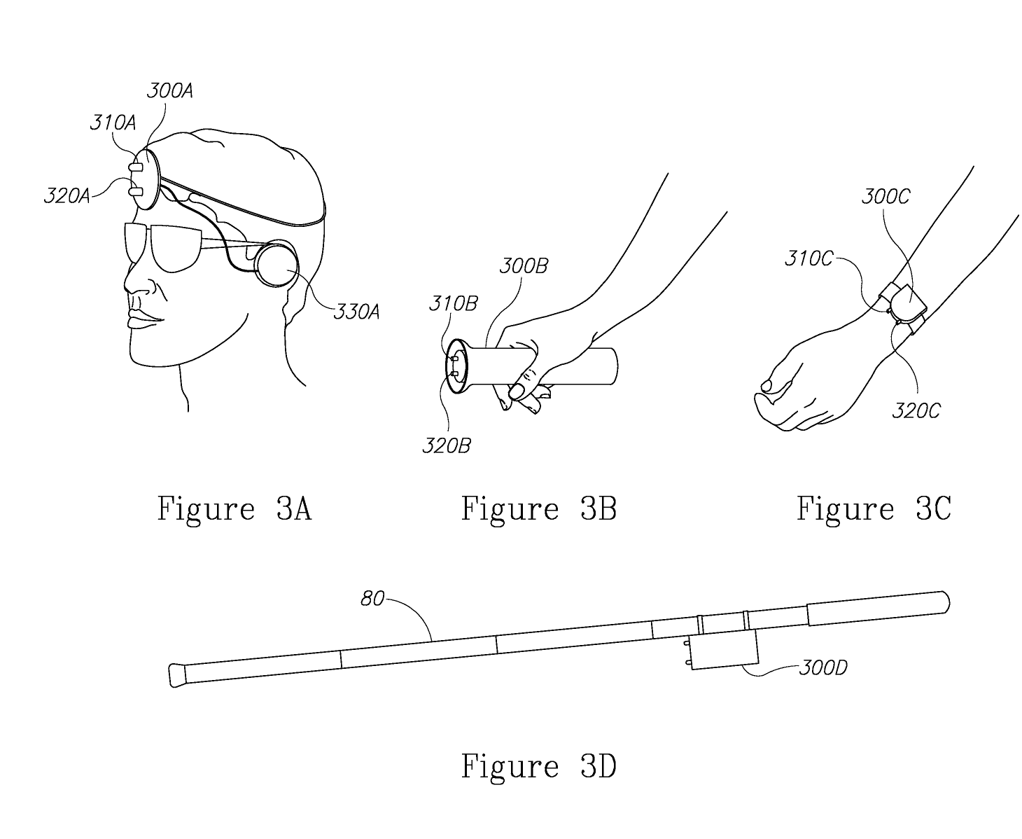

FIGS. 3A-3D are perspective views illustrating aspects according to some embodiments of the invention. As shown in FIG. 3A, the device may be formed in a shape of a head mounted gear 300A showing emitter 310A, sensor 320A, and headphones 330A. As shown in FIG. 3B, the device may be formed in a shape of a flashlight 300B showing emitter 310B, sensor 320A. As shown in FIG. 3C, the device may be formed in a shape of a wrist watch 300C showing emitter 310C and sensor 320C. Finally, the device could also be further combined with a white cane. As shown in FIG. 3D. The device 300D is adapted for coupling to a standard white cane 80, for example near the end where the person holds white cane 80. In this configuration, the blind or visually impaired person may use the white cane regularly while receiving further or overlapping information from device 300D. For example, the white cane may provide information regarding very short ranges while the device 300D provides information from farther parts of the scene. This combined configuration may also be used during the training period of device 300D after which, the white cane is eliminated.

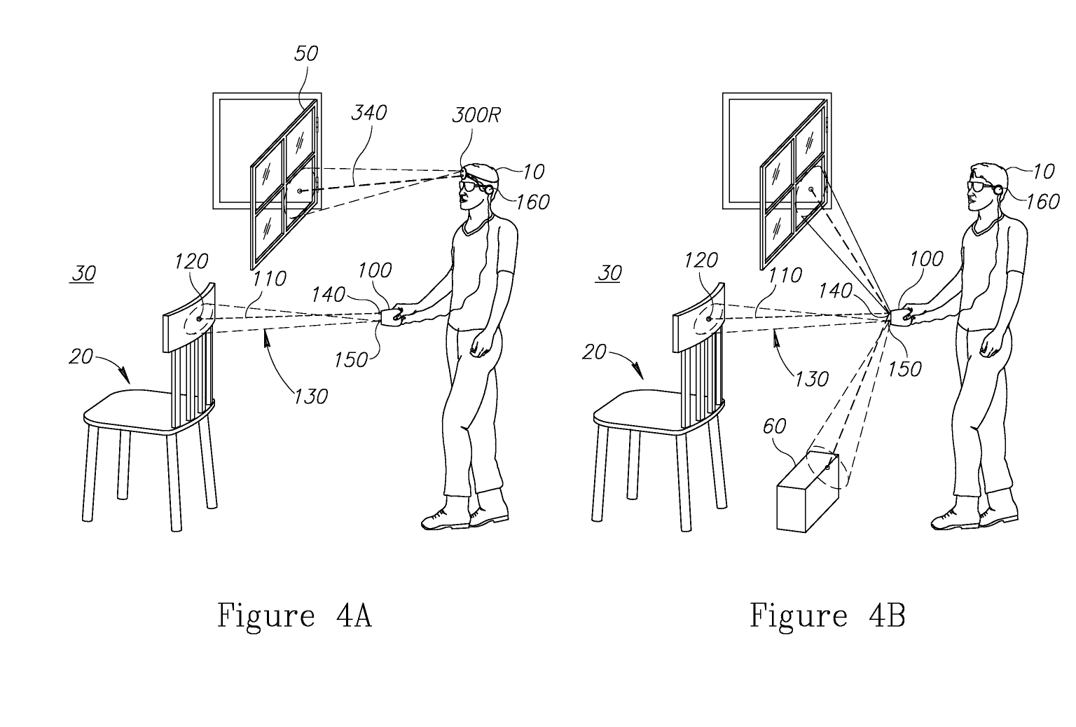

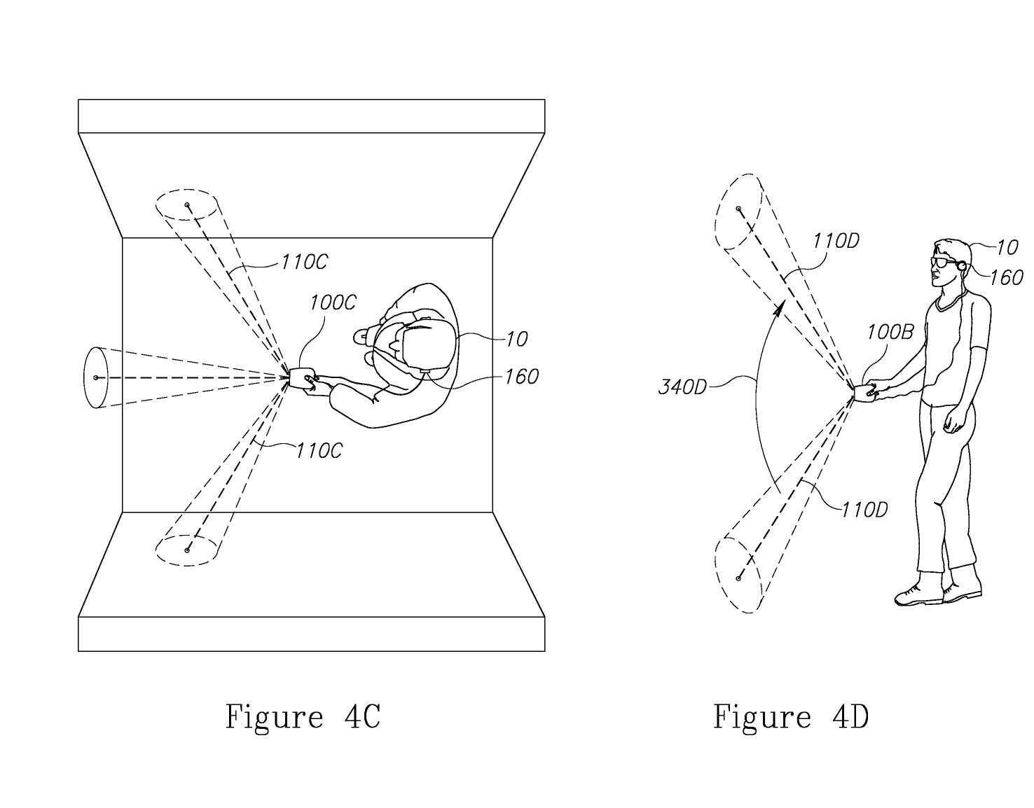

FIGS. 4A-4D are perspective views showing several configurations for using device 100. In FIG. 4A, a hand held device 100 is used in conjunction with the head gear version of the device 300A. This complementary configuration is advantageous since person 10 may now receive information regarding the lower and the upper portion of his or her walking path 30. Hand held device 100, illuminates, using emitter 140 an IR beam 110 that creates a spot 120 on chair 20. Similarly, head gear version of device 300A illuminates window 50 with IR beam 340. Person 10 receives distinct forms of sensual indication (auditory or vibratory) for each one of the portions (head and hand) so that a more comprehensive perception of the scene is provided. Advantageously, the complementary use of the head gear version 300 may aid in avoiding collision with highly located obstacles as is all too common with the use of standard white canes.

FIG. 4B shows a hand held device 100 in the configuration of several pairs (three shown here) as discussed above in regards with FIG. 2B. Each one of the pairs is directed at a different angle (here: top, middle, bottom) each one of the pairs generates an IR beam which is in turn reflected and detected such that each direction is associated with a distinct auditory or vibratory indication distinguishable from each other.

FIG. 4B shows a hand held device 100 in the configuration of several pairs (three shown here) as discussed above in regards with FIG. 2B. Each one of the pairs here is directed at a different angle (here: right, middle, left). As shown in this configuration, aligning the pairs in a horizontal alignment enables person 10 to receive good perception of the walls at his or her side, while walking in a corridor, for example.

FIG. 4D shows a hand held device 100 in the configuration of a single pair which is further provided with a scanning mechanism (mechanical, electronically or other) discussed in FIG. 2A above. This configuration enables a scanning of the scene according to a predefined learnable pattern or ad hoc, as determined by the person. This configuration eliminates the need for several pairs by assigning a distinguishable vibratory or auditory indicator for each angle, the pair is directed to.

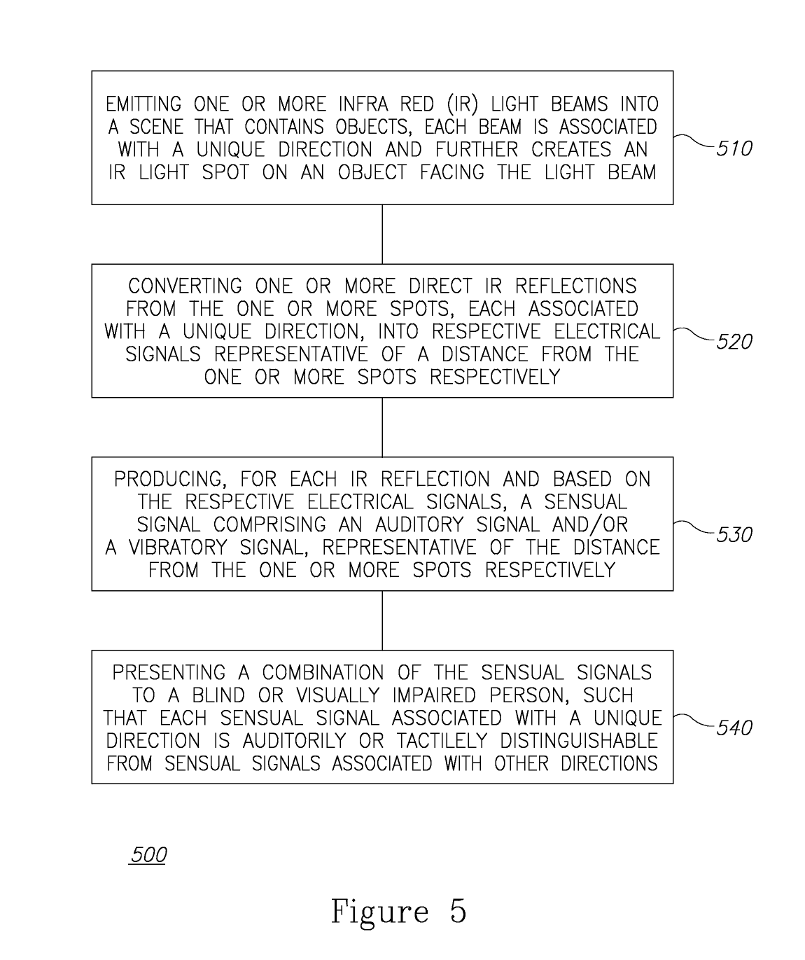

FIG. 5 is a high level flowchart illustrating a method according to some embodiments of the invention. Method 500 for guiding a blind or visually impaired person may be carried out using any architecture and is not necessarily limited to the aforementioned architecture of devices 100A or 100B. Method 500 starts with the stage of emitting one or more Infra Red (IR) light beams into a scene that contains objects; each beam is associated with a unique direction and further creates an IR light spot on an object facing the light beam 510. The method may go on to the stage of converting one or more direct IR reflections from the one or more spots, each associated with a unique direction, into respective electrical signals representative of a distance from the one or more spots respectively 520. Then the method proceeds to the stage of producing, for each IR reflection and based on the respective electrical signals and a respective conversion key, a sensual signal comprising an auditory and/or vibratory signal, representative of the distance from the one or more spots respectively 530. Finally, the method goes on to the stage of presenting a combination of the sensual signals, such that each sensual signal associated with a unique direction is auditorily or tactilely distinguishable 540.

Consistent with one embodiment of the invention, the conversion key is unique for each pair and selected such that the vibratory signal exhibits higher values of at least one of: frequency and amplitude, for shorter distances. Additionally or alternatively, the conversion key is unique for each pair and selected such that the auditory signal exhibits higher values of at least one of: pitch and amplitude, for shorter distances. Additionally or alternatively, the conversion key is unique for each pair and selected such it assigns a specified modulation for the auditory and vibratory signals respectively.

Consistent with one embodiment of the invention, method 400 may further include the stage of sensing a colour wavelength of the object associated with each spot; producing an indicator signal based on sensed wavelengths of colour light; and generating at least one of: an auditory signal and/or a vibratory signal based on said wavelength of the received color light of the respective objects.

Consistent with one embodiment of the invention, method 400 may further include the stage of assigning a unique musical instrument for each auditory signal associated with an IR reflection arriving from a different direction, such that the respective auditory signal is presented in the assigned musical instrument.

Consistent with one embodiment of the invention, method 500 may further include the stage of refreshing the light beams in a rate sufficiently high and calibrating the conversion keys such that pointing the one or more light beams continuously, yields a distinguishable change in the auditory or vibratory signals.

Consistent with one embodiment of the invention, method 500 may further include the stage of refreshing the light beams in a rate sufficiently high and calibrating the conversion keys such that a continuous change in the distance from the person to the one or more spots results in a continuous change in the respective auditory or vibratory signals.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A system comprising one or more devices for guiding a blind or visually impaired person, each one of the devices comprising:
one or more Infra Red (IR) emitter-sensor pairs, each pair having an emitter and a sensor pointing at a same spatial angle;
a sensual signal generator; and
an output unit,
wherein the emitter in each one of the pairs is configured to emit an IR light beam into a scene that contains objects, each beam is associated with a unique direction and further creates an IR light spot on an object facing the emitter,
wherein the sensor in each one of the pairs is configured to convert a direct IR reflection arriving from the spot associated with a respective emitter, into a respective electrical signal representative of a distance from the spot to the respective emitter,
wherein the sensual signal generator is configured to produce, for each IR reflection and based on the respective electrical signals and a respective conversion key, a sensual signal comprising at least one of: an auditory signal and a vibratory signal, representative of the distance from the device to the one or more spots respectively, and
wherein the output unit is further configured to present a combination of the sensual signals to the blind or visually impaired person, such that each sensual signal associated with a unique direction is auditorily or vibratorily distinguishable from sensual signals associated with other directions.

2. The system according to claim 1, wherein the conversion key is unique for each pair and selected such that the sensual signal exhibits higher values of at least one of a list comprising:
pitch, frequency and amplitude, for shorter distances.

3. (canceled)

4. The system according to claim 1, wherein the conversion key is unique for each pair and selected such it assigns a specified modulation for the auditory and vibratory signals respectively.

5. The system according to claim 1, wherein the modulation of the signal and/or the location of an actuator for vibratory signals is unique for each pair.

6. The system according to claim 1, wherein the one or more emitters are selected such that the respective IR light beams exhibit at least one of a beam angle equal to or smaller than 5° and a refresh rate equal to or greater than 50 Hz.

7. (canceled)

8. The system according to claim 1, wherein the one or more sensors further comprise a colour detector configured to generate colour indicator signals based on specified wavelengths of colour light received by the colour detector, and wherein the sensual signal generator is further configured to generate the least one of: an auditory signal and a vibratory signal also based on the wavelength of the received colour light from each one of the one or more sensors.

9. The system according to claim 1, wherein the sensual signal generator is further configured to assign a unique musical instrument for each auditory signal associated with an IR reflection arriving from a different direction.

10. The system according to claim 1, wherein the light beams exhibit a refresh rate sufficiently high and wherein the conversion keys are calibrated such that pointing the one or more emitters continuously yields a distinguishable change in the auditory or vibratory signals.

11. The system according to claim 1, wherein the light beams exhibit a refresh rate sufficiently high and wherein the conversion keys are calibrated such that a continuous change in the distance from the device to the one or more spots results in a continuous change in the respective auditory or vibratory signals.

12. The system according to claim 1, wherein the device weighs below 200 grams.

13. The system according to claim 1, wherein the device is formed in a shape of at least one of a list comprising a flashlight, a head mounted gear and a band which can be worn anywhere, in one or more locations, upon the body.

14. (canceled)

15. (canceled)

16. The system according to claim 1, further comprising a scanning unit coupled to each one of the pairs such that each one of the emitters and the sensors are configured to move co-ordinately and scan the scene in a specified pattern.

17. The system according to claim 1, wherein each one of the devices is held by or worn on a different portion of the person, and wherein the auditory and vibratory signals are distinguishable for each one of the devices.

18. A method for guiding a blind or visually impaired person, the method comprising:
emitting one or more Infra Red (IR) light beams into a scene that contains objects, each beam is associated with a unique direction and further creates an IR light spot on an object facing the light beam;
converting one or more direct IR reflections from the one or more spots, each associated with a unique direction, into respective electrical signals representative of a distance from the one or more spots respectively;
producing, for each IR reflection and based on the respective electrical signals and a respective conversion key, a sensual signal comprising at least one of: an auditory signal and a vibratory signal, representative of the distance from the one or more spots respectively; and
presenting a combination of the sensual signals to a blind or visually impaired person, such that each sensual signal associated with a unique direction is auditorily or tactilely distinguishable from sensual signals associated with other directions.

19. The method according to claim 18, wherein the conversion key is unique for each pair and selected such that the sensual signal exhibits higher values of at least one of: pitch, frequency and amplitude, for shorter distances.

20. (canceled)

21. The method according to claim 18, wherein the conversion key is unique for each pair and selected such it assigns a different location upon the body for the vibratory signal, or a specified modulation for the auditory and vibratory signals respectively.

22. The method according to claim 18, further comprising sensing a colour wavelength of the object associated with each spot; producing an indicator signals based on sensed wavelengths of colour light; and generating the at least one of: an auditory signal and/or a vibratory also based on the wavelength of the received colour light of the respective objects.

23. The method according to claim 18 further comprising assigning a unique musical instrument for each auditory signal associated with an IR reflection arriving from a different direction, such that the respective auditory signal is presented in the assigned musical instrument.

24. The method according to claim 18, further comprising refreshing the light beams in a rate sufficiently high and calibrating the conversion keys such that pointing the one or more light beams continuously, yields a distinguishable change in the auditory or vibratory signals.

25. The method according to claim 18, further comprising refreshing the light beams in a rate sufficiently high and calibrating the conversion keys such that a continuous change in the distance from the person to the one or more spots results in a continuous change in the respective auditory or vibratory signals.
